(19) United States
(12) Patent Application Publication
(10) Pub. No.: US 2012/0202628 A1
(43) Pub. Date: Aug. 9, 2012

(54) Controllable Hydraulic Turnbuckle

(75) Inventors: Marc-François Six, Corquilleroy (FR); Pascal Lambert, Pressigny-Les-Pins (FR)

(73) Assignee: HUTCHINSON, Paris (FR)

(21) Appl. No.: 13/387,279

(22) PCT Filed: Jul. 22, 2010
(86) PCT No.: PCT/FR10/00533

§ 371 Date: Apr. 6, 2012

(30) Foreign Application Priority Data
Jul. 30, 2009 (FR) 09 03769

(51) Int. Cl. F16H 7/12

(52) U.S. Cl. 474/110

(57) ABSTRACT

The invention relates to a controllable hydraulic turnbuckle for a power transmission member having a first mode of operation with increased forces and a second mode of operation with less forces, comprising: first (10) and second (11) lower and upper assembly elements, respectively, arranged at axially opposite ends; a tube (7) rigidly connected to the first assembly element (10) inside which a piston (5) slides, said piston being rigidly connected to the second assembly element (11); a resilient sleeve (3) surrounding the tube (7) and the piston (5), defining a low-pressure chamber (21); a prestressed spring (12) between the first (10) and second (11) assembly elements; a first channel (62, 63) provided inside the first (10) assembly element for placing the low-pressure chamber (21) and the inside of the tube (7) in communication, said first channel being provided with a first plugging device (8); a second channel (51, 52) provided in said piston (5), the end of which leads into the tube (7), said second channel being suitable for connecting a high-pressure chamber (20), located between the through-ends of the first (62, 63) and second (51, 52) channels, to the low-pressure chamber (21); and a second plugging

The invention relates to a linear hydraulic turnbuckle for a power transmission member having two modes of operation, in particular, but not exclusively, for a reversible member that may be a driving member or a receiving member, notably an alternator-starter motor separate from the crankshaft of an internal combustion engine and equipped with such a turnbuckle, as well as an automobile vehicle internal combustion engine driving system, that system notably including an alternator-starter motor and a crankshaft both equipped with transmission pulleys connected by a belt tensioned by said turnbuckle.

The field concerned is that of the transmission of power and more particularly, but not exclusively, reversible automobile vehicle internal combustion engine driving systems, notably disposed between a crankshaft and an alternator-starter motor connected by an elastic connecting member such as a belt.

The invention may equally be applied to all fields that necessitate transmission of power by rotary machines or motors, for example in industrial installations.

It is known to integrate the internal combustion engine starter motor function with the alternator function, producing what is called an alternator-starter motor. This integration eliminates the starter motor and a heavy toothed ring otherwise coupled to a flywheel of high inertia and to an electric starter motor.

The alternator-starter motor serves both as a driving member for starting the internal combustion engine via a flexible connecting member, the crankshaft pulley then behaving as a brake, and then as a receiving member once the engine has started in order to charge the battery (alternator function).

The integration may be effected either by direct coupling of the alternator mounted on the crankshaft, referred to as an integrated alternator-starter motor (IAS), or by an alternator-starter motor in a belt transmission (replacing the standard alternator), referred to as a separate alternator-starter motor (SAS).

The integrated (IAS) solution has been proven to prevent good adaptability for mounting/demounting the system and, most importantly, imposes brutal and uncontrolled starting.

The separate (SAS) solution, with drive by means of a belt between the two members, the crankshaft and the alternator, enables greater adaptability for mounting and smoother starting. The belt is of the poly-V, notched or trapezoidal type. The present invention when applied to an alternator-starter motor belongs to this category.

Starting an internal combustion engine is a brutal dynamic phenomenon that fluctuates rapidly as a function of internal friction, variable according to the state of the linkage and successive compression cycles.

During this heavily loaded starting phase, the speed of the crankshaft increases suddenly and the crankshaft torque varies from resisting to driving. Under these conditions, the alternator-starter motor torque itself fluctuates between driving and resisting, respectively.

After starting, in the so-called “started” regime, the crankshaft becomes the driving member and the alternator-starter motor becomes the receiving member. In this mode of operation, the instantaneous speed of the crankshaft then varies substantially sinusoidally: this phenomenon is known as engine acyclism. These speed fluctuations are transmitted by the belt to the receiving members, such as the alternator (here the alternator-starter motor in alternator mode), compressor, water pump.

With an alternator-starter motor, the inertias being high, the dynamic torques generated have high amplitudes in started mode, alternately positive and negative despite the one-way rotation: these torques generate high variations in tension, with maximum tension levels and high loading of the components (belts, unit bearing tensioners or winders) and low minimum tensions that can cause poor driving (slipping) and noise.

The two modes of operation may be defined as follows:

A) In engine starting mode, the torque to be developed by the alternator-starter motor to drive the crankshaft may reach values of the order of 90 N.m maximum. This enables crankshafts to be driven having a resisting torque in the range 180 N.m to 270 N.m (with a reduction ratio of 2 to 3).

A standard starter motor is typically capable of delivering a maximum driving torque of the order of 30 N.m, which enables a maximum torque of 90 N.m to be delivered to the crankshaft, typically with a reduction ratio between the two members equal to 3.

If torques much greater than those of a standard alternator must be supplied to the crankshaft, the torque variations are large and jerks then provoke vibrations in the belt transmission and slipping of the belt.

It must also be noted that the positive and negative values of the torque are not necessarily symmetrical, because of the asymmetry of the damping effects (by friction) and mechanical dissymmetries in the movements, as much in starting mode as in started mode.

B) In started mode, the torque to be delivered is a combination of:
the dynamic torque generated by the inertia of the alternator-starter motor and by the acyclism of the engine,
the electrical torque necessary to supply electrical power (alternator function).

In started mode, the torques to be transmitted are much lower than in starting mode.

The two mode of operation are therefore very different.

The turnbuckle must be able to cater for these two modes, causing the product to function differently between the two modes:
Rapid response with the ability to provide a high force in starting mode, maintaining a sufficient minimum tension to limit slipping of the belt and to ensure that the engine starts.
Limitation of the forces in started mode to a value sufficient to drive ancillary equipment without the belt slipping and without overloading the bearings of the ancillary equipment and the belt.

Standard hydraulic turnbuckles are unable to provide the two modes correctly and simultaneously.

Two categories may be distinguished:

1) Systems Neither Controlled Nor Locked

These supply:
either too little force in starting mode, for example as in the device described in patent application FR2688565 (HUTCHINSON),
or too much force in started mode, for example as in the device described in U.S. Pat. No. 6,036,612 (NTN).

2) Controllable Turnbuckles or Turnbuckles with all or Nothing Locking on Starting

These turnbuckles function thanks to either complete locking of the turnbuckle on starting, the turnbuckle then behaving like a fixed turnbuckle, for example the turnbuckle described in PCT application WO 02/29287 (GATES Corp.), or external control of the pressure of the damping fluid by an electrically controlled servo-valve (for example as in PCT application WO 2006/053617 (INA-SCHAEFFLER KG).

Controllable turnbuckles are very complicated and may have a large overall size, the control means projecting from or lying outside the overall contour of a turnbuckle that is not controllable. Moreover, control logic must be provided to process an input signal (speed, engine load and/or ancillary equipment load information) and the expected output signal (turnbuckle force/travel).

One object of the invention is to avoid at least some of the above drawbacks thanks to a controllable hydraulic turnbuckle able to provide both modes of operation independently.

Another object of the invention is to propose a controllable hydraulic turnbuckle the overall size of which corresponds to the normal overall size of a turnbuckle that is not controllable and the operation and control of which are simple.

Accordingly, the invention concerns a controllable hydraulic turnbuckle for a power transmission member having a first mode of operation with high forces and a second mode of operation with lower forces, characterized in that it includes:
first and second, respectively lower and upper, assembly elements disposed at opposite axial ends;
a tube rigidly connected to the first assembly element inside which slides a piston rigidly connected to the second assembly element;
a resilient sleeve surrounding the tube and the piston and connected and sealed to the first and second assembly elements, said resilient sleeve defining a low-pressure chamber for a hydraulic fluid;
a prestressed spring between the first and second assembly elements;
a first channel provided inside the first assembly element for placing the low-pressure chamber and the interior of the tube in communication, said first channel being provided at its end opening into the tube with a first plugging device;
a second channel provided in said piston, one end of which opens into the interior of the tube through a lower portion of the piston, said second channel being adapted to connect a high-pressure chamber located between the open ends of the first and second channels and the low-pressure chamber; and
a second plugging device disposed in the second channel, movable between an open position and a closed position and associated with control means located in the piston.

The control means preferably comprise an electromagnetic coil adapted to be supplied with current to create a magnetic field passing through the second plugging device.

Thus the second plugging device comprises a magnetic material plugging part supplying the coil with current causing movement of said plugging part against the lower part of the piston, itself in magnetic material, the second plugging device then being in a closed position.

In one variant, the second plugging device also comprises a ball placed in a cavity of said plugging part opening toward the interior part of the piston, said ball being intended to plug said second channel in the closed position of the plugging device.

The facing walls of the plugging part and the lower wall of the piston may be conical or substantially plane.

In this second variant, the wall preferably includes, around the second channel, a seat for said ball.

The plugging part is preferably of cylindrical general shape.

The plugging part preferably includes at least one orifice extending along the axis of the turnbuckle and over all the height of said part.

Said at least one orifice advantageously opens onto the cylindrical exterior wall of said part.

The second channel also includes means for limiting movement of said plugging part away from the lower part of the piston.

The first plugging device also includes a gravity-sensitive ball.

In one embodiment the first assembly member advantageously includes a fixing member on which is mounted a first endpiece including said first channel, while the second assembly member includes a fixing member on which is mounted a second endpiece on which said piston is mounted.

Other features and advantages of the invention will become more apparent on reading the following description, given by way of nonlimiting example and with reference to the drawings, in which:

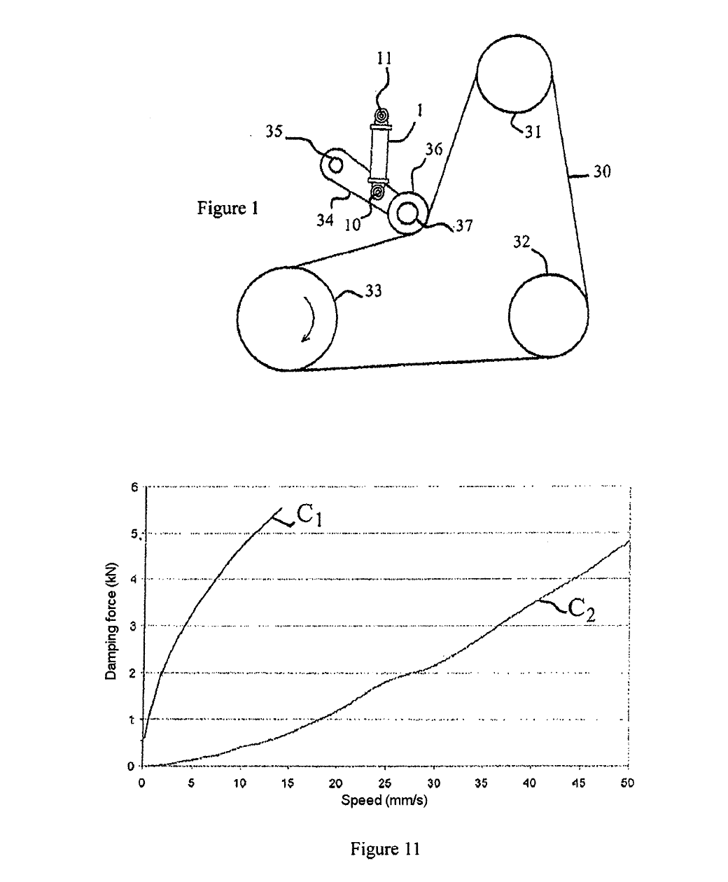

FIG. 1 is a diagrammatic view of a belt power transmission system using a controllable hydraulic turnbuckle of the invention,

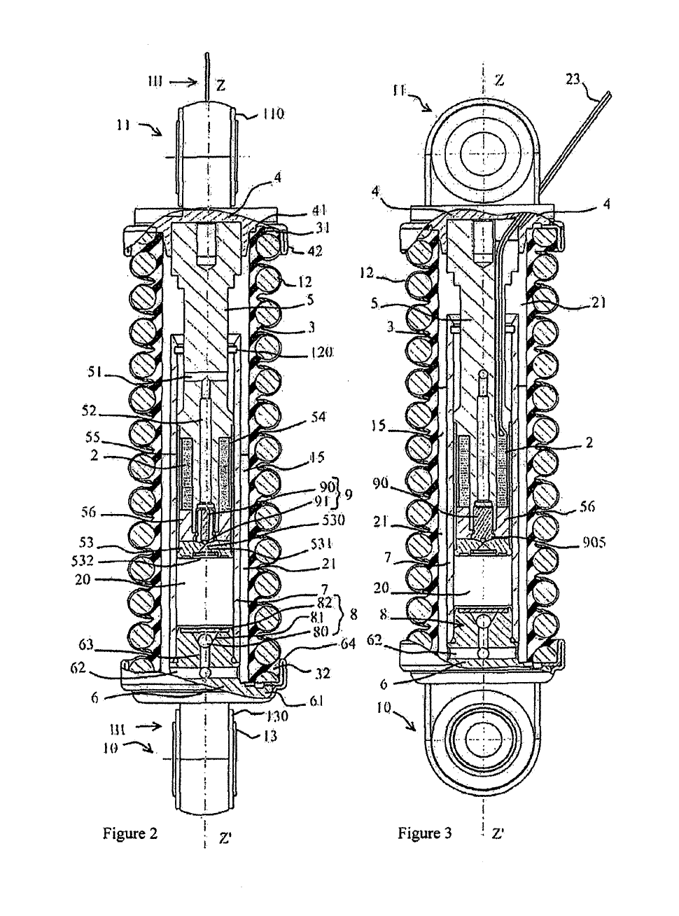

FIG. 2 is a partial longitudinal sectional view of a turnbuckle of the invention in an assembled and free state with the engine stopped,

FIG. 3 is a partial sectional view taken along the line of the FIG. 2 turnbuckle in a compressed state,

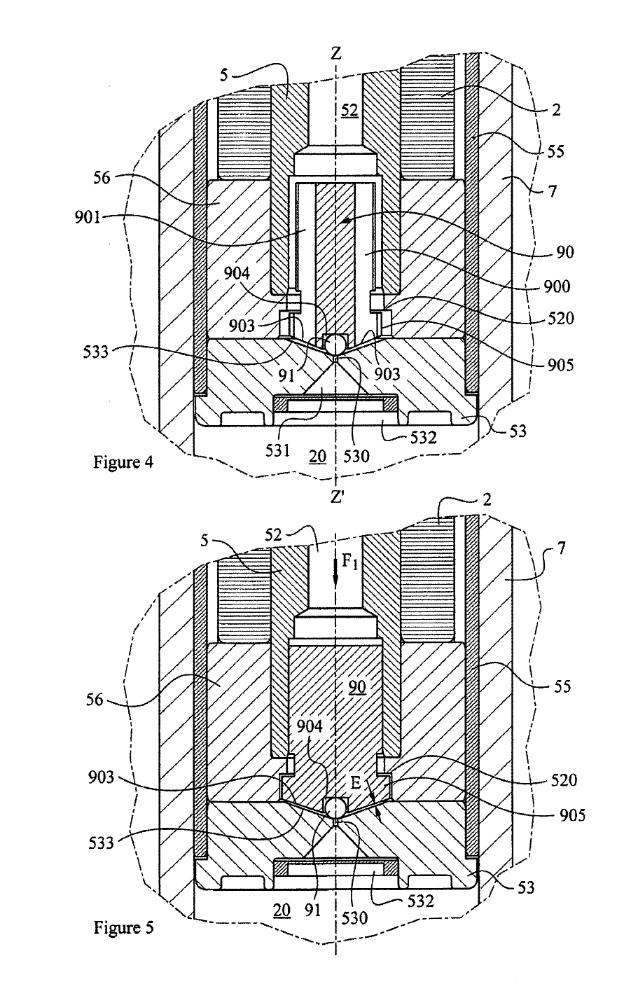

FIG. 4 is a view to a larger scale of the lower part of the piston of the turnbuckle shown in FIG. 2 (in the free state),

FIG. 5 is a view to a larger scale of the lower part of the piston of the turnbuckle shown in FIG. 3 (in the compressed state, in starting mode),

FIG. 6 is a view similar to FIG. 5 for the turnbuckle shown in FIG. 2 (in the compressed state, in started mode),

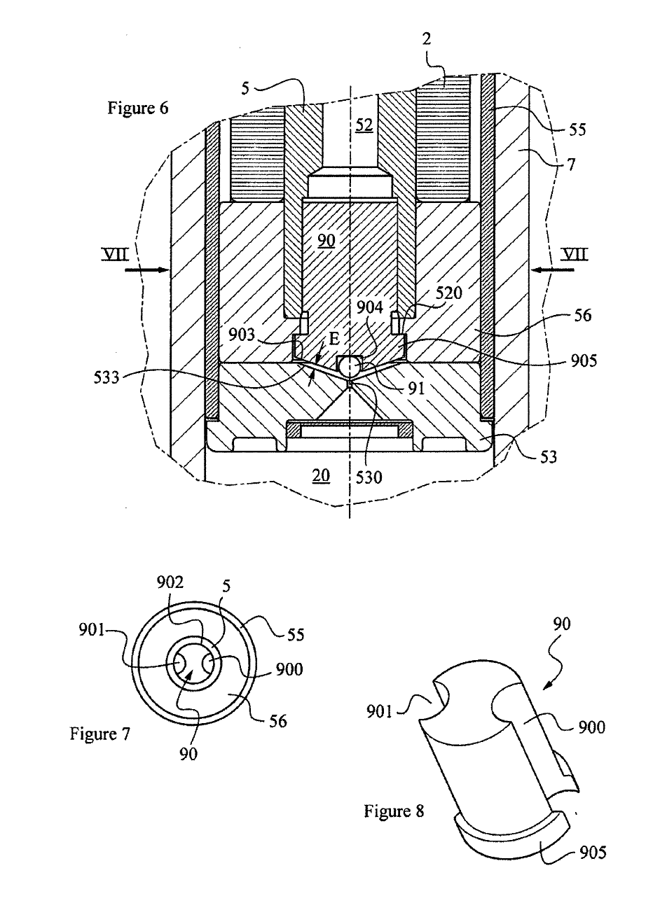

FIG. 7 is a partial view in section taken along the line VII-VII in FIG. 6,

FIG. 8 is a perspective view of a second plugging device of the turnbuckle of the invention as shown in FIG. 7,

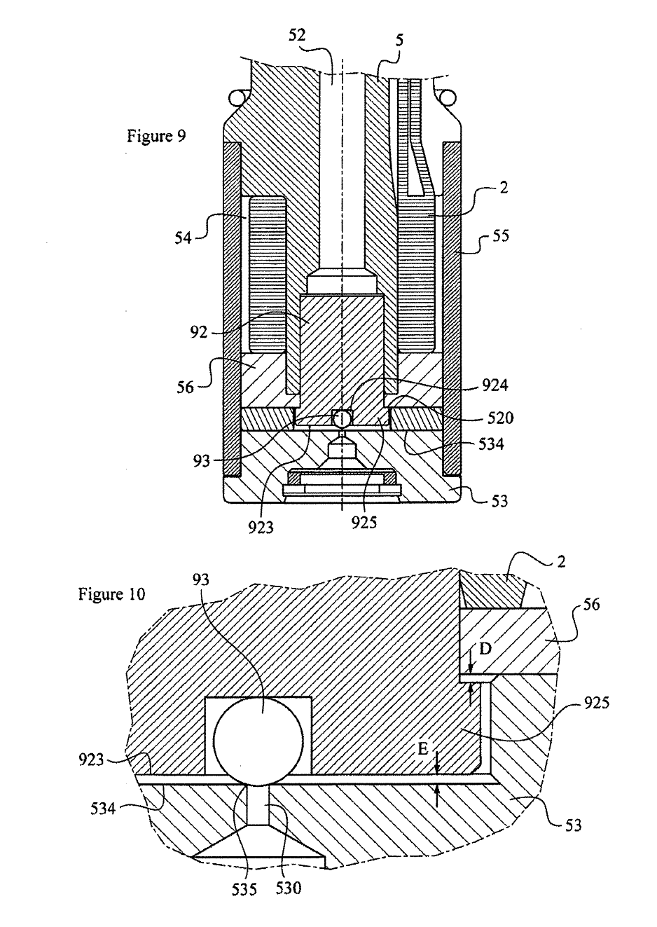

FIG. 9 shows a variant of the turnbuckle of the invention,

FIG. 10 is a view to a larger scale of a detail from FIG. 9,

FIG. 11 reproduces two curves showing the evolution of the damping force of the turnbuckle as a function of the rate of linear compression when the second plugging device is in the closed state (C₁) or in the open state (C₂), and

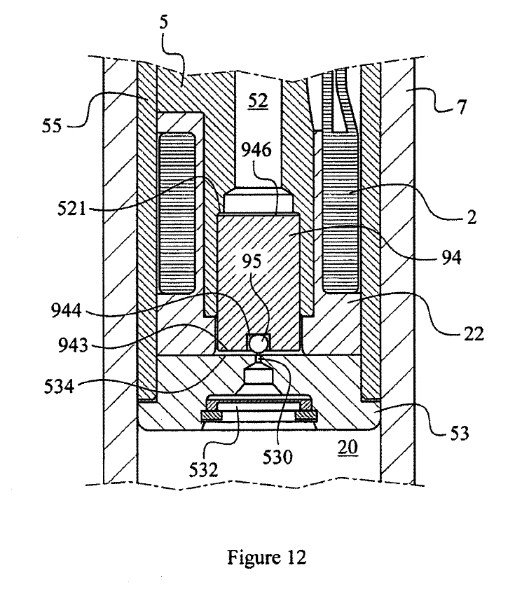

FIG. 12 shows another variant of the turnbuckle of the invention.

Refer first of all to FIG. 1 which shows diagrammatically a power transmission system in which a belt 30 cooperates with pulleys 31 and 32 constrained to rotate with driven shafts and with a pulley 33 fastened to a driving shaft, for example the crankshaft of an automobile engine or the like.

To tension the belt 30, there is associated with the system a turnbuckle 1 attached at the level of a lower assembly element 10 to a lever 34. This lever is mounted to pivot at one of its ends about an axis 35 and carries at its other end a roller 36 turning about an axis 37 and bearing on the belt 30.

The turnbuckle 1 also includes an upper assembly element 11 that is fixed to the engine block, which is not shown in FIG. 1.

The turnbuckle 1 is intended, on the one hand, to take up stretching of the belt 30 in order to prevent it slipping relative to the pulleys and on the other hand to damp vibrations generated in the belt 30 by cyclic irregularities of the operating conditions of the engine, in particular when idling or when jerks are generated by starting and/or stopping devices that are driven by the shafts to which the pulleys 31 and 32 are fastened.

As shown in FIG. 1, the point at which the turnbuckle 1 is fixed to the engine block (upper assembly element 11) and the roller 36 are advantageously on the same side of the belt, so that a reduction in the tension in the belt leads to an increase in the distance separating the lower and upper assembly elements 10 and 11, and vice-versa.

The description continues next with reference to FIG. 2, which shows a turnbuckle of the invention in longitudinal section.

This turnbuckle 1 shown in longitudinal section in FIG. 2 is intended to be mounted in a vertical position (axis ZZ′ vertical) as shown in FIG. 1 or inclined at an angle of 40° to 45° at most.

In FIG. 2, the turnbuckle 1 is in the mounted and free state, i.e. no dynamic load is exerted on it. In practice, the engine with which the FIG. 1 transmission system is associated is stopped.

The lower assembly element 10 includes for example an insert 13 bearing on a smooth bearing 130 intended to be connected to the articulated arm 34 equipped with the roller 36 that tensions the belt 30, while the upper assembly element 11 has a smooth bearing 110 adapted to be mounted at the engine end, this element 11 being fixed.

The turnbuckle includes a spring 12 of particular stiffness, for example 30 N/mm. In the assembled state, the turnbuckle is prestressed to limit the assembly travel. The prestressing is produced by a clip 120 forming an abutment that prevents the piston 5 of the turnbuckle rising upward. The prestressing force is of the order of 600 N, for example.

A flexible, for example rubber, sleeve 3 mounted in a sealed manner defines the external contour of a low-pressure chamber 21 containing oil 15.

In the examples shown in the figures, the sleeve and the spring are fastened together by an overmolding process.

The invention is not limited to this embodiment and the sleeve and the spring could equally be separate.

The sleeve 3 is held rigidly by its end flanges 31 and 32 on the upper and lower ends 4 and 6 thanks to shouldered cups 42 and 64 resting on the plane faces of flanges 41 and 61 of the endpieces 4 and 6. The cups 42 and 64 are pressed axially onto the flanges 41 and 61 by the compression force of the spring 12, which produces the seal.

The lower endpiece 6 is rigidly connected to the ball-joint insert 13 thanks to a screw (not shown) passing through the insert 13 and clamped axially thereto. The upper endpiece 4 is connected to the ball-joint insert 11 articulated by a screw (not shown) passing through the insert 11 and clamped axially thereto.

A tube 7 is rigidly connected to the lower endpiece 6. The endpiece 6 includes at least one radial channel 62 communicating with the low-pressure chamber 21 between the tube 7 and the sleeve 3 and closed at its axial ends by the endpieces 4 and 6.

In the endpiece 6, an axial channel 63 is provided that opens into the interior of the tube 7, in the high-pressure chamber 20 delimited by the upper end of the endpiece 6, the lower end of the piston 5 and the tube 7, and which is connected to the radial passage 62.

At the end of the axial channel 63 opening into the chamber 20 there is provided a first plugging device 8. This includes a ball 80 that rests by virtue of its weight on a seat 81, for example a frustoconical seat, into which the channel 63 opens. The ball 80 cannot escape into the high-pressure chamber 20 because of a cap 82 fastened to the lower endpiece 6.

The piston 5 is rigidly connected to the upper endpiece 4. This piston 5 includes at least one radial channel 51 communicating between the exterior of the piston and the interior of the tube 7. On the piston 5 there is also provided an axial channel 52 that opens into the high-pressure chamber 20 through the lower part 53 of the piston. To this end, the lower part 53 is pierced by a calibrated orifice 530 that opens into a frustoconical cavity 531 which itself opens into the high-pressure chamber 20.

The calibrated orifice 530 is centered on the axis ZZ′ of the turnbuckle 1.

FIG. 2 also shows a filter 532 that prevents any particles present in the oil from passing through the calibrated orifice 530.

In the channel 52 there is provided a second plugging device 9 that includes a plugging part 90 or needle that is shown to a larger scale in FIGS. 4 to 6.

The lower part of the channel 52 is widened to receive the part 90.

This part has a generally cylindrical shape and preferably at least one orifice extending axially.

Thus FIG. 7 shows the part 90 in cross section (taken along the line VII-VII in FIG. 6). It shows two axial orifices 900 and 901 which here open onto the cylindrical external wall 902 of the part 90. This latter part is also shown in perspective in FIG. 8.

By way of example, the total section of the orifices 900 and 901 is greater than 10 times the section of the calibrated orifice 530.

In the embodiment shown in FIGS. 2 to 6, the part 90 includes on its lower axial wall 903 a substantially cylindrical cavity 904 that is centered on the axis ZZ′ of the turnbuckle. In this cavity 904 there is provided a ball 91. A radial clearance is provided between the ball 91 and the cavity 904.

In the example shown in FIGS. 2 to 6, the wall 903 is frustoconical and the facing wall 533 of the lower part 53 of the piston is also frustoconical. The slopes of the walls 903 and 533 are substantially identical and define an airgap E.

As shown more precisely in FIGS. 4 to 6, the plugging part 90 includes a wider head 905 at the same end as the lower part 53 of the piston or the ball 91.

This wider head 905 comes to abut against a shoulder 520 of the channel 52 when the part 90 slides in the channel 52 as shown by the arrow F, which limits its movement.

Associated with the second plugging device 9 are control means composed essentially of an electromagnetic coil 2.

As notably shown in FIG. 2, this coil 2 is accommodated inside the body of the piston 5.

Thus an annular cavity 54 is formed in the body of the piston 5. This cavity extends along the axis ZZ′ of the turnbuckle and opens onto the cylindrical exterior wall of the body of the piston 5.

The coil 2 is typically an enameled copper wire coil that is wound onto the body of the piston about the axis ZZ′ of the turnbuckle.

The body of the piston 5 is produced in a magnetic material, like the jacket 55 that closes the cavity 54 and extends into the lower part 53 of the piston. Similarly, the plugging part 90 and the lower part 53 of the piston are produced in a magnetic material.

In the embodiment shown in FIGS. 2 to 6, and in that shown in FIGS. 9 and 10, an amagnetic material part 56 is provided axially between the coil 2 and the lower part 53 of the piston 5. However, as explained hereinafter, this amagnetic material part could be dispensed with in other embodiments of the turnbuckle.

The coil 2 is supplied with current by the means 23, which are shown in FIG. 3 in particular.

The jacket 55 provides a plurality of functions, and in particular a sealing function to protect the coil 2 from the oil 15. It also enables adjustment of the leakage clearance between the piston 5 and the tube 7 over the height of the piston 5 situated inside the tube 7.

Finally, it provides mechanical retention of all of the parts situated in the lower part of the piston and notably of the lower wall 53 of the piston, which is built into the jacket 55.

As will emerge in the remainder of the description, it also enables channeling of the essential part of the magnetic flux created by the coil 2 when energized.

In the idle position shown in FIGS. 2 and 4, the ball 91 is pressed by its weight onto the frustoconical wall 533.

The oil 15 may circulate through the high channels 51 and 52 and the low channels 62 and 63, the high-pressure chamber 20, the low-pressure chamber 21, as described hereinafter.

The functioning of the turnbuckle from FIG. 2 is explained hereinafter with reference to FIGS. 2 to 6.

The turnbuckle is generally shipped in the premounting position in which the turnbuckle is at a minimum distance between centers position. To mount it, the retainer is released and the turnbuckle expands into the FIG. 2 position.

In the idle state, shown in FIG. 2, the lower ball 80 bears on its seat 81 and closes the oil passage. The upper ball 91 rests on the seat 533 by gravity alone and the oil passage is open.

At the moment of starting (FIGS. 3 and 5), the coil 2 is energized to close the airgap E between the plugging part 90 and the lower part 53 of the piston. The channel 52 is then closed.

Indeed, when the coil 2 is supplied with current, it creates an electromagnetic field that passes through the body of the piston 5, the plugging part 90, the lower part 53 of the piston and then the magnetic jacket 55.

Clearly the amagnetic part 56 interleaved between the coil 2 and the lower part 53 forces the magnetic flux created by the coil to cross the airgap E that is present between the plugging part 90 and the lower part 53.

Because of the effect of this magnetic flux, the plugging part 90 slides in the channel 52 and is moved in the direction of the arrow F₁ (FIG. 5) to come substantially into contact with the frustoconical walls 533 because of the reduction of the airgap.

The channel 52 is also closed by the ball 91. Thanks to the radial clearance between the ball 91 and the cavity 904, the ball is perfectly centered in the bottom of the frustoconical wall 533 to close the calibrated orifice 530.

Once the orifice 530 is closed, the force retaining the plugging device 9 on the lower part 53 of the piston increases because of the reduction of the airgap. Because of this, this retaining force is sufficient to compensate the thrust of the fluid that is exerted on the ball 91 via the orifice 530 that it plugs. In practice, the magnetic force created by the coil is exerted essentially on the ball 91.

The response time of the plugging part 90 to closure depends mainly on its mass and on the characteristics of the coil 2 and the airgap E. The channel 52 is generally closed by the plugging device 9 within a delay of about a few tens of milliseconds.

The coil is advantageously energized before starting becomes effective, to be sure of closing the channel 52 on starting.

Moreover, the turnbuckle is compressed (increased torque) and the tube 7 rises very fast along the piston 5 toward the element 11. The lower ball 80 is still pressed onto its seat 81 and closes the channel 63.

The piston is then in the position shown in FIG. 3. FIG. 3 shows the turnbuckle from FIG. 2 in section taken along the line W-III. Accordingly, in this FIG. 3, the orifices 900 and 901 of the plugging part 90 are not visible.

The two plugging devices 8 and 9 are thus in their plugging position. The result of this is an immediate and large increase in pressure causing a large increase in the force necessary to tension the belt on starting and to prevent it slipping. Passage of fluid between the high-pressure chamber 20 and the low-pressure chamber 21 is effected only via the leakage clearances, notably between the piston 5 and the tube 7. This is what is required.

Starting of the engine by a separate alternator-starter motor (SAS) generates a large but brief and local variation in the tension of the belt between the driving SAS pulley and the driven engine shaft. This run of the belt has to withstand a high level of tension during starting by the SAS. The hydraulic turnbuckle of the invention controls closing of the second plugging device 9. This enables the stiffness of the dynamic turnbuckle to be greatly increased when the SAS starts the engine, enabling starting to be achieved within a short time period and without additional noise from the transmission.

The curve C₁ in FIG. 11 shows the evolution of the damping force of the turnbuckle as a function of the speed of relative movement of the tube 7 and the piston 5 (also known as the linear compression speed) when the plugging device 9 is closed and at ambient temperature.

The curve C₁ confirms that the dynamic stiffness of the turnbuckle is greatly increased at relatively low speeds.

The operation that has just been described applies not only to starting the engine but also once the engine has been started if the SAS is used to provide in parallel with the engine additional mechanical power. This mode of operation is commonly referred to as boost mode.

In the started state, the large torque variations are reduced and the turnbuckle is merely loaded by dynamic variations caused in part by the acyclism of the engine.

Energization of the coil 2 is stopped and the plugging device 9 is therefore in the open position.

To separate the plugging part 90 from its seat, it may be fed briefly (for a few milliseconds) with a negative current. This enables the remanent magnetic field in the magnetic parts of the piston and consequently the residual force holding the plugging device 9 in the closed position to be cancelled out.

Under these conditions of alternating loadings with short travels, the plugging device 9 remains in the open position, with an airgap E also open, and the plugging device 8 is between two positions. Its movement depends on the movement of the piston 5. It will be noted that the amplitude of the movement of the piston 5 in this state is of the order of 1 mm to 5 mm. Two situations may then be distinguished:

A) Expansion direction: on movement of the tube 7 (away from the element 11), the two plugging devices 8 and 9 are in the open position.

The pumping effect raises the lower plugging device 8 by suction, which frees the channel 63. Moreover, the ball 91 is free in the cavity 904. Opening the plugging device 8 enables the necessary replenishing with oil of the high-pressure chamber 20. The oil is replenished from the low-pressure chamber 21 to the high-pressure chamber 20 via the channels 51 and 52, 61 and 63.

For maximum efficacy, the high-pressure chamber 20 must be full of oil 15 at all times. The presence of air severely compromises correct operation of the turnbuckle (damping problems).

It must be noted that in the open state of the two plugging devices 8 and 9, when the piston 5 rises the turnbuckle operates essentially on the stiffness of the spring 1 (ignoring the friction of the oil) and the tension of the belt is at the minimum necessary for operation.

B) Compression direction (FIG. 6): the lower plugging device 8 is closed and the upper plugging device 9 is open.

The ball 80 remains pressed onto its seat 81 and closes the channel 63 and therefore blocks the passage of oil from the low-pressure chamber 21.

The curve C₂ shows the evolution of the damping force of the turnbuckle as a function of the linear compression speed under normal operating conditions. The curve C₂ shows that in the started state the stiffness characteristic of the turnbuckle of the invention is adapted to the SAS regeneration mode. This prolongs the life of the belt of the transmission system thanks to a reduction in tension and enables an improved overall energy efficiency of the vehicle to be achieved.

The upper plugging device 9 being open, the passage of the fluid from the high-pressure chamber 20 to the low-pressure chamber 21 is effected not only via the leakage clearances between the piston and the tube but also via the plugging device 9. The passage of the fluid is further facilitated by the presence of the axial orifices 900 and 901. Moreover, the ball 91 rises in the cavity 904 because of the effect of the passage of the fluid. The stiffness of the turnbuckle therefore increases much less rapidly during a compression phase in started mode than during a compression phase in starting mode (see curve C₁).

Thus the turnbuckle of the invention enables two independent modes of operation to be obtained, perfectly adapted to the modes of operation of the engine and from the beginning of each mode of operation.

This independence of the started and starting modes is increased if there is provision for separating the plugging part 90 from its seat after stopping energization of the coil.

Under extreme conditions, namely in some cases of sudden variations of tension in started mode (at the idling limit of the engine, incident caused by ancillary equipment jamming, etc.), the control means of the second plugging device are actuated so that the two plugging devices 8 and 9 are closed, which produces a greater force to limit the risk of the belt slipping.

Moreover, the control means of the second plugging device are disposed in the body of the piston and not externally of the flexible sleeve that defines the exterior contour of the turnbuckle. The overall size of the turnbuckle of the invention therefore corresponds to the normal overall size of a turnbuckle that cannot be controlled. This is an important advantage of the turnbuckle of the invention compared to known controllable turnbuckles.

Embodiments of the hydraulic turnbuckle of the invention are described next.

Refer first to FIGS. 9 and 10.

FIG. 9 shows the bottom part of a piston 5, the turnbuckle being in the free state. As shown in FIGS. 2 to 6, this piston 5 includes a coil 2 accommodated in a cavity 54 of the piston and protected by a jacket 55.

The lower part of the axial channel 52 is enlarged to receive a plugging part 92. This plugging part 92 includes an enlarged head 925 that is able to abut against the shoulder 520 of the channel 52.

When the turnbuckle is in the free state, the upper part of the head 925 is at the distance D away from the shoulder 520.

As before, the body of the piston 5, the jacket 55, and the lower part 53 of the piston are produced in a magnetic material, like the plugging part 92. The intermediate part 56 is produced in an amagnetic material, however.

FIGS. 9 and 10 show that the lower axial wall 923 of the plugging part 92 is plane and not frustoconical.

In this variant, the facing wall 534 of the lower part 53 of the piston is also plane.

The plugging part 92 includes a substantially cylindrical cavity 924 that opens onto its lower axial wall 923. In this cavity 924 there is a ball 93 with a radial clearance.

FIG. 10 shows in more detail the airgap E produced between the lower axial wall 923 of the plugging part 92 and the facing wall 534 of the lower part 53 of the piston.

A hemispherical seat 535 is preferably created on the lower part of the piston by a punching process. The presence of this seat enables the positioning of the ball 93 on the axis of the calibrated orifice 530 to be improved.

In a variant embodiment of the turnbuckle of the invention, the ball 91 or 93 of the plugging device is fastened to the plugging part 90 or 92. In this embodiment, the plugging part is placed in the channel 52 with sufficient clearance to make up for any defect in the coaxial relationship of the ball and the calibrated orifice 530, to guarantee efficacious closure of the calibrated orifice.

In another variant, the ball of the plugging device is eliminated. Moreover, the plugging device 9 has a plane lower wall facing a plane wall of the lower part of the piston.

This embodiment has a lower manufacturing cost than the previous ones but may offer lower performance.

In the embodiments shown in FIGS. 2 to 10, the amagnetic ring delimits axially a groove enabling the coil 2 to be produced directly on the body of the piston.

FIG. 12 shows the bottom part of a piston 5 and shows that the amagnetic ring may be dispensed with.

The plugging part 94 is a cylindrical part with no enlarged head, in contrast to the plugging parts 90 and 92 shown in the other figures.

It is then the upper axial wall 946 of the plugging part that is able to abut against the shoulder 521 of the channel 52.

The lower axial wall 943 of the plugging part is plane, as is the facing wall 534 of the lower part 53, and a cavity 944 receives a ball 95, as in the embodiment shown in FIGS. 9 and 10.

The reference 532 designates a filter.

Moreover, the coil 2 is produced on an amagnetic material, for example plastic, former 22, this assembly then being placed in a cavity provided in the body of the piston 5.

Another variant consists in placing in the body of the piston a coil produced with or without a former, using thermo-adherent wire, and then molding a plastic material over this coil ensuring the magnetic flux passes into the plugging part when the coil is fed with current as well as protecting the coil.

A few examples of dimensions are given next for the controllable hydraulic turnbuckle of the invention.

The turnbuckle, by virtue of its coil spring 12, initially ensures a static pre-loading tension in the belt in the range 700 to 1200 N. In operation, the dynamic axial forces in play on compression of the turnbuckle are divided into a damping component and an elastic component. The latter component remains low compared to the pre-loading component and the damping component, the elastic stiffness of the turnbuckle being of the order of 30 N/mm.

In starting mode the turnbuckle is subjected to compression forces in the range approximately 4 to 8 kN. In started mode, these compression forces are typically less than 2 kN.

By way of example, the hydraulic turnbuckle of the invention includes a high-pressure chamber 20 with a diameter in the range 10 to 13 mm, the diameter of the calibrated orifice 530 being in the range 0.1 to 0.2 mm, and the radial leakage clearance between the piston 5 and the tube 7 being in the range 5 to 20 μm.

Clearly plugging the calibrated orifice necessitates generation of a force for retaining the plugging part 90 or 92 that is proportional to the maximum damping force generated, for example 7 kN.

This retaining force depends on the geometry of the plugging part.

For the dimensions given above, this retaining force is of the order of 2 N for a plugging part the end face of which is plane (as in the embodiment shown in FIGS. 7 and 8) and approximately 6 N for a plugging part the lower end face of which is conical (as in the embodiment shown in FIGS. 2 to 6).

For example, a coil comprising 54 turns of a 0.5 mm diameter bare copper wire accommodated in a cavity having an inside diameter of 6 mm, an outside diameter of 10.4 mm, and a height of 8.6 mm, fed with a current of 1.9 A, enables generation of a retaining force of 6 N with a plugging device of 5 mm diameter delimiting an airgap of 0.2 mm.

As a general rule, it is preferable for the airgap E to be less than 0.2 mm, or even 0.15 mm.

Moreover, the radial clearance between the plugging part 90, 92 and the channel 52 is preferably less than 100 μm.

To ensure closure of the second plugging device, the coil must of course be energized by a higher current.

Lower levels of current may then be applied to hold the plugging device 9 in the closed position.

The parts of the piston 5 that are produced in magnetic materials are preferably produced in mild steel, for example XC 18, XC 48 or XC 75 steel.

The reference symbols inserted after the technical features appearing in the claims are provided only to facilitate understanding thereof and should not be regarded as limiting their scope.

1. A controllable hydraulic turnbuckle for a power transmission member having a first mode of operation with high forces and a second mode of operation with lower forces, the turnbuckle:
first and second, respectively lower and upper assembly elements disposed at opposite axial ends;
a tube rigidly connected to the first assembly element inside which slides a piston rigidly connected to the second assembly element;
a resilient sleeve surrounding the tube and the piston and connected and sealed to the first ) and second assembly elements, said resilient sleeve defining a low-pressure chamber for a hydraulic fluid;
a prestressed spring between the first and second assembly elements;
a first channel provided inside the first assembly element for placing the low-pressure chamber and the interior of the tube in communication, said first channel being provided at the end thereof opening into the tube with a first plugging device
a second channel provided in said piston, one end of which opens into the interior of the tube through a lower portion of the piston, said second channel being adapted to connect a high-pressure chamber located between the open ends of the first (62 and second channels and the low-pressure chamber; and
a second plugging device disposed in the second channel and associated with control means located in the piston.

2. The turnbuckle claimed in claim 1, wherein said control means comprise an electromagnetic coil adapted to be supplied with current to create a magnetic field passing through the second plugging device.

3. The turnbuckle claimed in claim 2, wherein the second plugging device comprises a magnetic material plugging part supplying the coil with current causing movement of said plugging part against the lower part of the piston, itself in magnetic material, the second plugging device then being in the closed position.

4. The turnbuckle claimed in claim 3, wherein the second plugging device also comprises a ball placed in a cavity of said plugging part opening toward the interior part of the piston, said ball being intended to plug said second channel in the closed position of the plugging device.

5. The turnbuckle claimed in claim 3, wherein the facing walls of the plugging part and the lower wall of the piston are conical.

6. The turnbuckle claimed in claim 3, the facing walls of the plugging part and the lower part of the piston are substantially plane.

7. The turnbuckle claimed in claim 6, wherein the wall includes, around the second channel, a seat for said ball.

8. The turnbuckle claimed in claim 2, wherein said plugging part is of cylindrical general shape.

9. The turnbuckle claimed in claim 8, wherein said plugging part includes at least one orifice extending along the axis of the turnbuckle and over all the height of said part.

10. The turnbuckle claimed in claim 9, wherein said at least one orifice opens onto the cylindrical exterior wall of said part.

11. The turnbuckle claimed in claim 3, wherein said second channel includes means for limiting movement of said plugging part away from the lower part of the piston.

12. The turnbuckle claimed in claim 1, wherein the first plugging device includes a gravity-sensitive ball.

13. The turnbuckle claimed in claim 1, wherein the first assembly member includes a fixing member on which is mounted a first endpiece including said first channel.

14. The turnbuckle claimed in claim 1, wherein the second assembly member includes a fixing member on which is mounted a second endpiece on which said piston is mounted.
